(19) United States
(12) Patent Application Publication
(10) Pub. No.: US 2025/0385708 A1
(43) Pub. Date: Dec. 18, 2025

(54) ULTRA-WIDEBAND TRANSMITTER AND RECEIVER, AND WIRELESS APPLICATION METHOD THEREOF

(71) Applicant: Andong National University Industry-Academic Cooperation Foundation, Andong-si (KR)

(72) Inventor: Geunhaeng LEE, Suwon-si (KR)

(73) Assignee: Andong National University Industry-Academic Cooperation Foundation, Andong-si (KR)

(21) Appl. No.: 18/970,837

(22) Filed: Dec. 5, 2024

(30) Foreign Application Priority Data
Jun. 18, 2024 (KR) 10-2024-0078754

(51) Int. Cl. H04B 1/40; H04L 25/02

(52) U.S. Cl. CPC H04B 1/40; H04L 25/0212

(57) ABSTRACT

Proposed are ultra-wideband transmitter and receiver. The ultra-wideband round-trip wireless transceiver includes a master module comprising a first transmitter and a first receiver for ultra-wideband round-trip data communication, and a slave module comprising a second receiver and a second transmitter for the round-trip data communication, wherein the master module further includes a range finder module for two-way ranging that counts time simultaneously with transmission of an output signal of the first transmitter, and calculates a distance by receiving a signal output through the second transmitter at the first receiver by using a trigger according to the output signal of the first transmitter at the second receiver of the slave module.

### STATEMENT REGARDING GOVERNMENT SPONSORED RESEARCH

This invention was supported by the National Research Foundation of Korea funded by the Ministry of Education of Korea. [Research Project name: “Regional Innovation Strategy (RIS) based on local government-university cooperation”; Research Subject name: “(Daegu Gyeongbuk Regional Innovation Platform) Kyungpook National University”; Project Serial Number: 1345370813; Research Subject Number: 2022RIS-006]

### CROSS REFERENCE TO RELATED APPLICATION

The present application claims priority to Korean Patent Application No. 10-2024-0078754, filed Jun. 18, 2024, the entire contents of which are incorporated herein for all purposes by this reference.

### BACKGROUND OF THE INVENTION

### Field of the Invention

The present disclosure relates to ultra-wideband transmitter and receiver, and a wireless application method thereof.

### Description of the Related Art

Research is being conducted on ultra-wideband (UWB) technology which uses very short pulses to transmit data, enabling wide frequency bandwidth, low power consumption, high-speed data transmission, and precise location tracking, etc.

This ultra-wideband (UWB) technology has applications in a variety of fields, including indoor positioning, vehicles, healthcare, and gaming.

Meanwhile, ultra-wideband (UWB) technology is being developed, for example, according to the IEEE 802.15.4z standard.

A communication method based on the standard described above offers advantages in terms of overall protocol consistency and system management.

However, adopting the communication method based on the standard may lead to an increase in the size of hardware (HW), such as modems and memory, which in turn results in larger chip sizes and potentially higher chip unit prices. Additionally, in terms of power consumption, instantaneous power reaches several hundred milliwatts (mW), posing many limitations on the application of the technology and presenting problems.

### SUMMARY OF THE INVENTION

Accordingly, the present disclosure has been made keeping in mind the above problems occurring in the related art, and an objective of the present disclosure is to propose an ultra-wideband (UWB) transmitter capable of transmitting data to simultaneously enable ultra-precision distance measurement and data communication while consuming ultra-low power.

Another objective of the present disclosure is to propose an ultra-wideband (UWB) receiver corresponding to the above-mentioned ultra-wideband (UWB) transmitter.

Another objective of the present disclosure is to propose a wireless application method through the above-mentioned ultra-wideband (UWB) transmitter and receiver.

Another objective of the present disclosure is not limited to what is described in this section, but includes what can be understood from the description of the invention described below.

In order to achieve the objectives of the present disclosure, according to at least one of various embodiments of the present disclosure, there is provided an ultra-wideband round-trip wireless transceiver including: a master module comprising a first transmitter and a first receiver for ultra-wideband round-trip data communication; and a slave module comprising a second receiver and a second transmitter for the round-trip data communication, wherein the master module further includes a range finder module for two-way ranging that counts time simultaneously with transmission of an output signal of the first transmitter, and calculates a distance by receiving a signal output through the second transmitter at the first receiver by using a trigger according to the output signal of the first transmitter at the second receiver of the slave module.

According to at least one of various embodiments of the present disclosure, the master module may include: a first part for generating pulses; and a second part for transmitting signals comprising the pulses.

According to at least one of various embodiments of the present disclosure, the first part may include: a modulator that modulates input data; a window generator for a pulse trigger; and an impulse generator module for synchronization.

According to at least one of various embodiments of the present disclosure, the impulse generator module may include: timing combine logic; and a push-pull strength stage processing module.

According to at least one of various embodiments of the present disclosure, the slave module may include: a first part for receiving and processing an output signal of the master module; and a second part that generates a signal to be output to the master module.

According to at least one of various embodiments of the present disclosure, the first part may include: a plurality of amplifiers; a detector for self-mixing; and a comparator for pulse detection.

According to at least one of various embodiments of the present disclosure, the second part may process a data demodulation path and a range finder path by distinguishing between the data demodulation path and the range finder path.

According to at least one of various embodiments of the present disclosure, the data demodulation path may include: a data demodulator for demodulating data from an output of the comparator; and a synchronization processing part configured to generate samples for pulse-based synchronization and to generate a recovery clock on the basis of the samples.

According to at least one of various embodiments of the present disclosure, the range finder path may be formed by an edge detector for detecting an edge from an output of the comparator, and a time-to-digital converter with a two-step Vernier structure for distance measurement.

According to at least one of various embodiments of the present disclosure, the slave module may use a detection structure with a non-coherent structure.

According to at least one of various embodiments of the present disclosure, the range finder module may calculate the distance from time divided by speed of light on the basis of time of flight (ToF).

According to at least one of various embodiments of the present disclosure, the modulator may use a synchronized on-off keying (S-OOK) technique as a modulation technique for the data communication of the round-trip.

According to at least one of various embodiments of the present disclosure, the slave module may use a sync pulse and a data pulse to transmit data from an input clock according to the output signal of the first transmitter.

According to at least one of the various embodiments of the present disclosure, there are the following advantages.

First, it is possible to provide an ultra-wideband (UWB) wireless transmitter/receiver capable of transmitting data to simultaneously enable ultra-precision distance measurement and data communication while consuming ultra-low power.

Second, it is possible to reduce the size of various types of hardware mounted in a chip to reduce the size of the chip, thereby lowering the unit price of the chip.

Third, it is possible to be applied to various applications and fields on the basis of the ultra-wideband (UWB) wireless transmitter/receiver that is capable of operating at ultra-low power.

The technical effects of the embodiments are not limited to those described in this section, but include those that can be understood through the description of the invention.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a conceptual diagram of an ultra-wideband round-trip wireless system according to an embodiment of the present disclosure;

FIG. 2 is a configuration block diagram of an ultra-wideband round-trip wireless transmitter according to an embodiment of the present disclosure;

FIG. 3 is a configuration block diagram of an ultra-wideband round-trip wireless receiver according to an embodiment of the present disclosure; and

FIG. 4 is a diagram illustrating an example of the timing diagram of an overall system utilizing two-way ranging (TWR).

### DETAILED DESCRIPTION OF THE INVENTION

Hereinafter, the present disclosure according to embodiments for solving the above problems will be described in more detail with reference to the drawings.

Terms “module” and “part” used in the following description for components are given simply for the convenience of writing this specification, and do not in themselves impart any particularly important meaning or role. Therefore, the “module” and “part” may be used interchangeably.

Terms including ordinal numbers, such as first, second, etc., may be used to describe various components, but the components are not limited by the terms. The above terms are used solely to distinguish one component from another.

Singular expressions include plural expressions unless the context clearly indicates otherwise.

In this application, it should be understood that the terms “include”, “have”, or “provided with” are intended to specify the presence of a feature, number, step, operation, component, part, or combination thereof described in the specification, but do not exclude in advance the possibility of the presence or addition of one or more other features, numbers, steps, operations, components, parts, or combinations thereof.

The lack of applications, which was a limitation of the IoT (Internet of Things), is being significantly resolved by the precision of communication and distance measurement of an ultra-wide band (UWB) system.

For example, an ultra-wideband wireless system is being effectively applied or is expected to be applied in various fields, such as digital interfaces and smart keys resulting from the combination of the flagship smartphones of manufacturers and vehicle electrical systems, and the harmony of real estate applications and digital door locks.

In addition, the ultra-wideband wireless system may be utilized in various smart systems closely related to our lives, such as vehicle electrical systems, parking lot systems, and support systems in a home environment in addition to the examples mentioned above, and is expected to be applied to many fields due to its high value.

However, despite various studies based on these expectations of necessity and usability, there are still many issues to be resolved, such as issues on hardware (HW) size and resulting chip size, a power consumption issue, and a chip unit price issue.

Accordingly, this specification describes ultra-wideband (UWB) wireless transmitter and receiver and a wireless application method thereof, which enable data to be transmitted to simultaneously enable ultra-precision distance measurement and data communication while consuming ultra-low power according to the present disclosure.

In particular, in the present specification, a round-trip wireless system is used as an example for the aforementioned technical objectives. However, the present disclosure is not limited thereto.

Hereinafter, various embodiments of the present disclosure will be described in more detail with reference to the accompanying drawings.

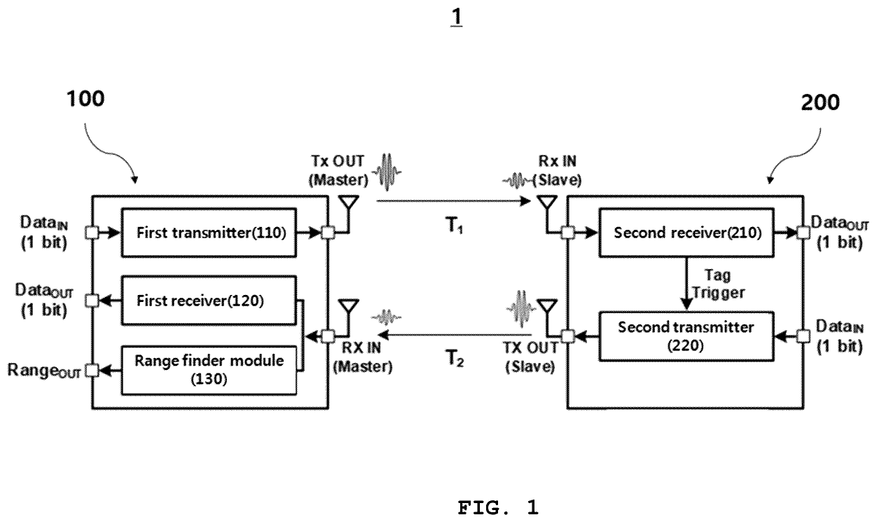

FIG. 1 is a conceptual diagram of an ultra-wideband round-trip wireless system according to an embodiment of the present disclosure.

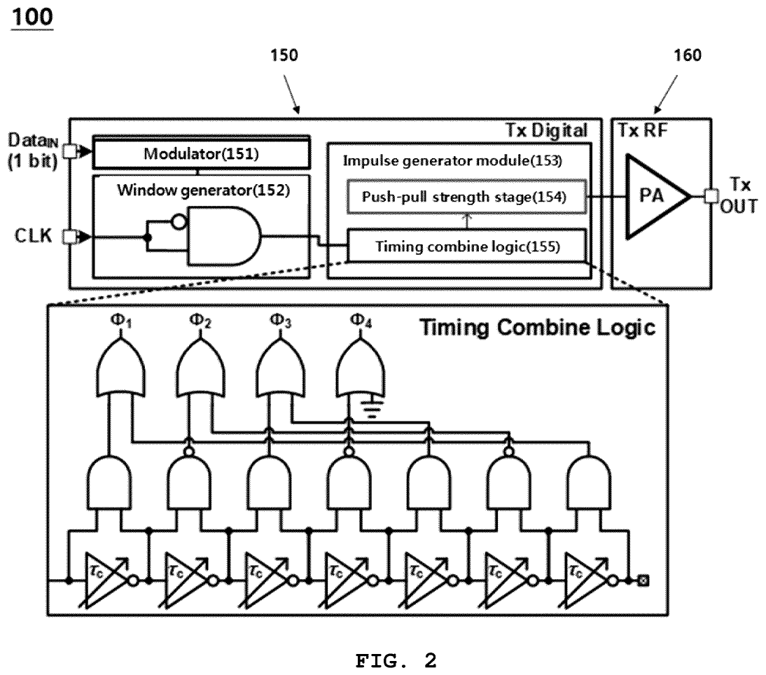

FIG. 2 is a configuration block diagram of an ultra-wideband round-trip wireless transmitter according to an embodiment of the present disclosure.

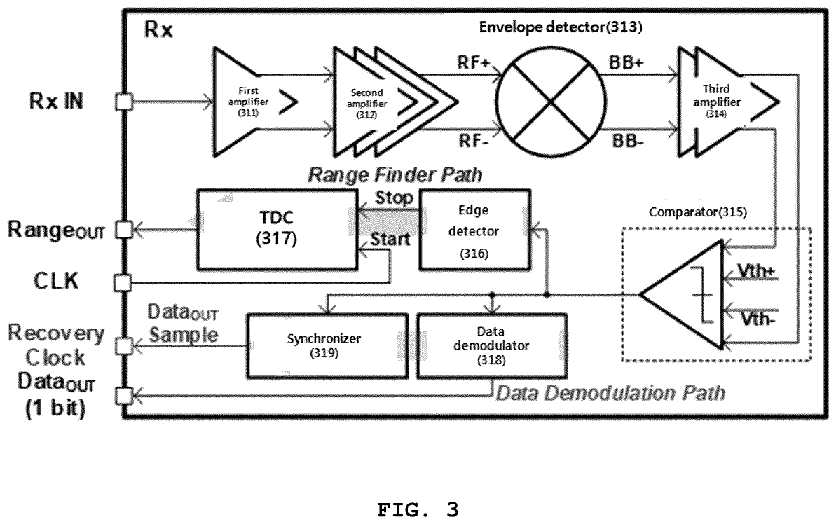

FIG. 3 is a configuration block diagram of an ultra-wideband round-trip wireless receiver according to an embodiment of the present disclosure.

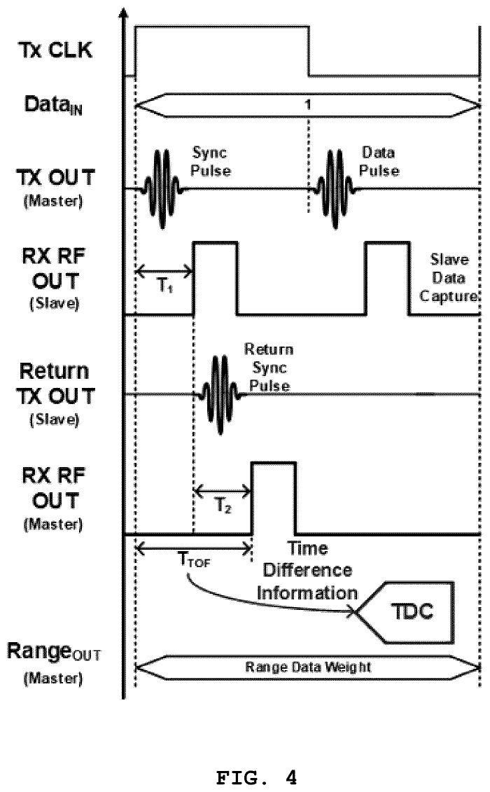

FIG. 4 is a diagram illustrating an example of the timing diagram of an overall system utilizing two-way ranging (TWR).

First, FIG. 1 illustrates a module of an ultra-wideband (UWB) round-trip wireless system capable of performing data communication and location tracking (i.e., distance measurement) simultaneously.

Referring to FIG. 1, the ultra-wideband (UWB) round-trip wireless system 1 includes a first module 100 and a second module 200.

In this case, the first module 100 is a master module that controls and synchronizes a wireless system capable of two-way data communication. This master module is also called an anchor.

On the other hand, the second module 200 is a slave module that operates under the control of the master module mentioned above. This slave module is also called a tag.

The master module 100 may include a first transmitter 110 and a first receiver 120 for data communication in the ultra-wideband round-trip wireless system.

The master module 100 may further include a range finder module 130 in addition to the first transmitter 110 and the first receiver 120. In this case, the range finder module 130 may be integrated into the master module 100.

The range finder module 130 may be a range finder module for two-way ranging (TWR) technology for two-way distance measurement to be described later.

This range finder module 130 may count time simultaneously with the transmission of the output signal of the first transmitter 110.

Afterwards, the range finder module 130 may calculate distance data by receiving a signal output through a second transmitter 220 at the first receiver 120 by using a trigger according to the output signal of the first transmitter 110 at a second receiver 210 of the slave module.

The slave module 200 may include the second receiver 210 and the second transmitter 220 for round-trip communication.

Referring to FIG. 4, the two-way ranging (TWR) is described as follows.

The two-way ranging (TWR) is a technique for measuring a distance between two devices, for example, the master module 100 and the slave module 200, in the ultra-wideband (UWB) wireless system.

In other words, the two-way ranging (TWR) is a method of calculating the distance by measuring time it takes for a signal to be transmitted from one device (the master module 100) to another device (the slave module 200) and back again, and this method may be used usefully when the signal propagation speed is known.

The two-way ranging (TWR) may calculate the distance by measuring the time of flight (ToF) (e.g., round-trip time) between two devices to accurately measure the distance between the two devices. In other words, the two-way ranging (TWR) measures time it takes to transmit and receive signals between the master module 100 and the slave module 200.

The master module 100 may record a timestamp (a first timestamp) when transmitting an initial signal to the slave module 200.

After receiving and processing the signal, the slave module 200 may record a timestamp (a second timestamp) and may transmit a response signal to the master module 100.

When the master module 100 receives the response signal from the slave module 200, the master module 100 may record a timestamp (a third timestamp) for the time of receiving the response signal.

Afterwards, the master module 100 may calculate total round-trip time (ToF), and the slave module 200 may calculate time (processing time) it takes to prepare and transmit the response signal and transmit the time to the master module 100.

The master module 100 may calculate actual signal propagation time by using the values calculated above, and the distance between the two modules (devices) may be calculated on the basis of the calculated signal propagation time.

Meanwhile, in the above process, the signal propagation speed may be the speed of light (i.e., the speed of light in a vacuum).

FIG. 4 illustrates an overall system timing diagram according to the concept of the two-way ranging (TWR) described above, and FIG. 5 illustrates.

This two-way ranging (TWR) enables very precise distance measurement by utilizing the wide frequency band and short pulse width of ultra-wideband (UWB), supports more precise time synchronization through two-way communication, that is, two-way signal transmission, and has strong resistance against multipath, for example, robustness against multipath fading, so that stable distance measurement is possible even in indoor environments.

Therefore, the two-way ranging (TWR) technology may play a key role in a location tracking and distance measurement system in the ultra-wideband round-trip wireless system 1 according to the present disclosure.

In FIG. 2, an example of a block diagram illustrating the configuration of the master module 100 of the ultra-wideband (UWB) round-trip wireless system 1 is illustrated.

Referring to FIG. 2, the master module 100 may include a first part 150 for generating pulses and a second part 160 for transmitting signals including the pulses.

The first part 150 may be implemented in the form of a single chip with integrated digital logic elements.

On the other hand, the second part 160 may be implemented in the form of radio frequency (RF) with an amplifier (PA) included.

The first part 150 may include a modulator 151, a window generator 152, and an impulse generator module 153.

The modulator 151 modulates input data for communication.

In this case, the modulator 151 may use the technique of synchronized on-off keying (S-OOK), for example, as a modulation technique for data communication of round-trip.

The synchronized on-off keying (S-OOK), which is one of modulation techniques used in ultra-wideband (UWB) wireless communication systems, combines frequency and time synchronization techniques to increase the efficiency and reliability of data transmission.

This synchronized on-off keying (S-OOK) may improve the accuracy and transmission performance of signals through synchronization while using a simple OOK method.

The on-off keying (OOK) is a digital modulation method in which a signal is turned on to indicate a bit ‘1’ and a signal turned off to indicate a bit ‘0’.

Meanwhile, synchronization is the process of matching time and frequency between the master module 100 and the slave module 200 to ensure accurate data transmission and reception.

The synchronized on-off keying (S-OOK) is based on an OOK modulation method, but may perform signal generation and transmission processes, a synchronization process, signal reception and detection processes, and error detection and correction processes to make the transmission and reception of signals more accurate through synchronization between the master module 100 and the slave module 200.

Through this, in the synchronized on-off keying (S-OOK), a data signal may be transmitted by using a synchronized time slot so that the accuracy of the signal may be greatly improved, and resistance to noise may be increased through a synchronization signal so as to enable reliable data transmission, so that a performance may be improved through synchronization while maintaining the simple structure of OOK.

Meanwhile, the synchronized on-off keying (S-OOK) may be used to support synchronized communication between multiple devices simultaneously.

Accordingly, as an example, in the ultra-wideband (UWB) round-trip wireless system according to the present disclosure, a modulation method for transmitting data utilizes the synchronized on-off keying (S-OOK).

In addition, in the synchronized on-off keying (S-OOK), through synchronized communication, i.e., through a synchronized clock signal between the master module 100 and the slave module 200, data transmission between the two devices may be synchronized, and for the data transmission, for example, modulation is performed by using two transmission symbols. In this case, a “1” bit may mean generating a pulse in a frequency band, and a “0” bit may mean not transmitting.

Accordingly, the modulation technique using the synchronized on-off keying (S-OOK) enables high-speed data transmission, ultra-low power consumption, and multi-device synchronization.

Additionally, by using the synchronized on-off keying (S-OOK) in the ultra-wideband (UWB) round-trip wireless system 1, stable distance measurement and data communication may be simultaneously performed independently.

In this case, in stable distance measurement, the synchronized on-off keying synchronizes clock signals between the transmitter and receiver to control precise timing, ensuring precise time synchronization required for distance measurement in the system, and in high-resolution distance measurement, the system may measure a distance in high resolution through very short pulses and precise timing control.

Meanwhile, independent data communication involves the separation of pulses. That is, synchronized on-off keying (S-OOK) uses pulses for data communication, and the pulses are separated from pulses used for distance measurement, so that data communication and distance measurement may be performed independently of each other.

The window generator 152 supports a pulse trigger.

In the ultra-wideband (UWB) round-trip wireless system 1, the window generator 152 within the master module 100 controls signal generation and the temporal characteristics of a signal.

The window generator 152 may determine the time width of a signal for accurate distance measurement and communication and transmit a signal within a desired time interval.

The ultra-wideband (UWB) wireless system 1 according to the present disclosure, which is a communication method that uses a very wide frequency band, is characterized by high data transmission speed and low power consumption, and may transmit signals by using pulses with a very short time width (e.g., on the order of nanoseconds).

In relation to the present disclosure, the term “window” may represent a time interval during which a signal is transmitted.

Accordingly, the window generator 152 represents a device that generates and controls the window and may perform accurate time synchronization of signals and pulse generation.

The window generator 152 generates ultra-wideband (UWB) pulses with very short time width, and these pulses are repeated periodically, and each of the pulses may be transmitted at a precise time interval within the window.

The window generator 152 enables accurate signal reception and distance measurement through time synchronization, that is, accurate time synchronization between the master module 100 and the slave module 200.

The window generator 152 controls the start and end of the pulse to ensure that a signal is transmitted within an accurate time interval, and may optimize the temporal characteristics of the signal by adjusting the width and interval of the pulse.

The window generator 152 may include high-speed timer and counter, delay lines, logic control circuits, etc. for the above-described operations.

The impulse generator module 153 supports synchronization.

In this case, the impulse generator module 153 may include timing combine logic, a push-pull strength stage processing module.

The impulse generator module 153 may generate ultra-wideband (UWB) pulses used in the ultra-wideband (UWB) round-trip wireless system 1, and these pulses are used for data transmission and time measurement.

The impulse generator module 153 may generate ultra-wideband (UWB) pulses for communication and timing measurement, and adjust the frequency, width, and timing of the pulses to meet various communication requirements as needed.

Components of the impulse generator module 153 may include a waveform generator 154 that generates and controls the shape of a UWB pulse, and a timing and frequency control circuit 155 that controls and adjusts the timing and frequency of the pulse.

The first part 150 of the ultra-wideband (UWB) round-trip wireless system according to the present disclosure enables efficient wireless communication and time measurement by using the above-described components.

The second part 160 may amplify a signal processed by the first part 150 and transmit the amplified signal to the slave module 200.

FIG. 3 illustrates an example of a configuration block diagram of the slave module 200.

Referring to FIG. 3, the slave module 200 may include a first part for receiving and processing an output signal of the master module 100 and a second part for generating a signal to be transmitted to the master module 100.

In FIG. 3, the first part may include a first amplifier 311, a second amplifier 312, an envelope detector 313, a third amplifier 314, and a comparator 315.

The first amplifier 311 may be a low noise amplifier (LNA).

In the ultra-wideband (UWB) wireless system 1, the first amplifier 311 may be, in particular, a single-to-differential (S2D) LNA, which may convert a single-ended signal into a differential signal so as to minimize the noise of the signal.

As described above, the conversion and amplification process may have a significant impact on the performance and reliability of the ultra-wideband (UWB) wireless system 1 according to the present disclosure.

For example, the first amplifier 311, which is a first amplifier in the receiver, minimizes noise while amplifying a very weak signal coming from an antenna. Therefore, the performance of the amplifier 311 may have a significant impact on the signal-to-noise ratio (SNR) of the entire receiver.

In the present disclosure, by employing the S2D LNA as the first amplifier 311, noise minimization, distortion reduction, and electromagnetic interference (EMI) minimization may be achieved.

The second amplifier 312 may be an RG VGA amplifier.

The envelope detector 313 is for self-mixing.

In the ultra-wideband (UWB) wireless system 1, the envelope detector 313 for self-mixing detects and extracts pulses of a received ultra-wideband (UWB) signal.

In this case, the envelope detector 313 may extract the amplitude of a signal and convert it into digital data so as to process the received data.

The self-mixing mentioned above refers to a phenomenon in which a signal transmitted through a receiver antenna is mixed with a signal from a transmitter that generated the signal. This phenomenon plays a particularly important role in UWB wireless communication. That is, the system may extract signals from an antenna through self-mixing and restore data on the basis of the signals.

Meanwhile, the envelope detector 313 is capable of extracting, in particular, the amplitude of a received signal. For example, UWB signals consist of very short pulses, and the envelope detector 313 detects and extracts the amplitude of these pulses.

In this case, the envelope detector 313 is not sensitive to the shape or frequency of a pulse, but is sensitive only to the amplitude of a pulse.

This envelope detector 313 is composed of a diode and an RC circuit. The diode repeatedly rectifies an input signal, and the RC circuit smooths the rectified signal to extract amplitude thereof. In this case, when the input signal is positive, the diode may conduct, allowing the input signal to be amplified. When the input signal is negative, the input signal may be blocked by the diode.

The envelope detector 313 smooths an output signal, that is, the RC circuit smooths the input signal rectified by the diode to extract amplitude thereof, and through this, extracts the amplitude information of a pulse. In this case, the time constant of the RC circuit may be adjusted depending on the width of the pulse.

The envelope detector 313 supports digitization, which means that although an output is an analog amplitude signal, the signal may be converted into a digital signal for subsequent processing. An analog-to-digital converter (ADC) may be used to convert an analog signal into a digital signal, which may then be used in various digital signal processing technologies.

The third amplifier 314 may amplify the output of the envelope detector 313 for the input of the comparator 315 in the subsequent stage.

The comparator 315 may be for pulse detection. That is, the comparator 315 may detect pulses for communication and pulses for distance measurement.

The comparator 315 for pulse detection in the ultra-wideband (UWB) round-trip wireless system 1 may detect a pulse by comparing a received signal with a threshold.

The comparator 315 may detect whether or not a signal is present in the UWB system 1 and use this for round-trip (time-of-flight) measurement.

The comparator 315 compares the amplitude of a received UWB signal with a threshold to determine whether or not a pulse is present. In this case, the threshold may generally be set by taking into account the noise level and signal strength of the system.

The comparator 315 determines whether or not a signal is present, that is, detects a signal exceeding a threshold to confirm the presence of a pulse, and through this, the system 1 may determine whether or not a UWB signal is present in the surrounding environment.

The comparator 315 performs signal processing and analysis, meaning that detected pulses may be transmitted to a digital system for further processing and analysis, enabling tasks such as time measurement and position estimation.

The comparator 315 may include a comparison circuit for the above-described operation, and a threshold set by considering the noise level and signal strength of the system is set as an important parameter of the comparator 315, thereby allowing a desired signal detection level to be adjusted.

The comparator 315 may output a digital signal that typically represents two states, and for example, may output a logic state of “1” when a pulse is detected, and a logic state of “0” otherwise.

Meanwhile, in FIG. 3, the second part may process a data demodulation path and a range finder path by distinguishing between the data demodulation path and the range finder path.

Referring to FIG. 3, first, the data demodulation path may include a data demodulator for demodulating data from the output of the comparator, and a synchronization processing part which generates samples for pulse-based synchronization and generates a recovery clock on the basis of the samples.

The data demodulation path may be used to decode data received from the UWB system 1 and convert the decoded data into a digital form. That is, the data demodulation path is mainly involved in receiving and demodulating communication data.

The data demodulation path may include a frequency decoder, a digital signal processing device, a digital demodulator, etc.

The data demodulation path decodes a received UWB signal and converts the decoded UWB signal into digital data. For this, the frequency decoder converts the UWB signal into a digital signal, and the digital demodulator may decode the digital signal to extract original data.

The data demodulation path, which is used for demodulation and processing of communication data, may process data quickly and accurately through frequency decoding and digital demodulation, thereby lowering power consumption and complexity.

Next, the range finder path may be formed by an edge detector 316 for detecting an edge from the output of the comparator and a time-to-digital converter (TDC) 317 with a two-step Vernier structure for distance measurement.

The range finder path is mainly used for distance measurement in the UWB system 1. This path measures a distance on the basis of time difference between signals in the surrounding environment.

The range finder path may be processed by the edge detector 316 for detecting an edge of a signal and the time-to-digital converter (TDC) 317 with a two-step Vernier structure.

The TDC 317 described above accurately measures the arrival time of a received signal to determine a distance.

The range finder path may include a frequency generator, a phase-locked loop (PLL), and a TDC control circuit.

The range finder path calculates a distance by measuring time difference between a received signal and a transmitted signal. To this end, the TDC 317 first measures the gross value of the arrival time by synchronizing with a fixed delay time, and then measures a fine value to calculate an exact distance.

In this way, the slave module 200 according to the present disclosure processes two paths by distinguishing therebetween. That is, the range finder path may be mainly used for distance measurement, and the data demodulation path may be used for receiving and demodulating data.

Meanwhile, the range finder path measures the arrival time of a signal to calculate a distance, and the data demodulation path demodulates the received signal so that data may be interpreted.

Meanwhile, the range finder path requires ultra-low power and provides high precision for distance measurement, while the data demodulation path preferably ensures stable data reception and demodulation.

These two paths contribute to the overall performance and reliability of the UWB system 1, and each path for distance measurement and data communication operates independently of the other, ensuring the integrated functioning of the system.

Meanwhile, the slave module 200 may use a sync pulse and a data pulse to transmit data from an input clock according to the output signal of the master module 100.

In addition, the slave module according to at least one of the various embodiments of the present disclosure may use a detection structure with a non-coherent structure.

The non-coherent structure and ultra-low power implementation are two important factors to consider in the UWB communication system 1. The non-coherent structure enables the design of simple receiver and low power consumption, and the ultra-low power implementation may be essential especially in applications in which battery life is important.

Therefore, the present disclosure aims to combine the above-mentioned two factors to design an efficient and energy-saving UWB communication system.

The non-coherent structure is a structure that does not use the phase information of a carrier when receiving a signal. In contrast to the non-coherent structure, a coherent structure demodulates a signal by using the phase information of the signal.

Based on the non-coherent structure related to the present disclosure, the receiver may be designed with a relatively simple structure. For example, the receiver has a simple structure because the receiver does not require a phase-locked loop (PLL). For example, the receiver may use an energy detector to measure the energy of a signal and demodulate data on the basis of this energy.

In addition, in the non-coherent structure, since there is no complex phase synchronization process, power consumption may be reduced, and the simple architecture makes hardware implementation easier, thereby improving power efficiency.

In addition, the non-coherent structure is insensitive to phase noise, so the non-coherent structure may maintain noise-resistant performance, especially stable performance even in a multipath fading environment.

The slave module 200 with the non-coherent structure receives a UWB signal through an antenna by going through a filtering process, leaving only the necessary band, and measures the energy of the received signal to detect whether a data signal is present. For example, when the energy exceeds a certain threshold, the slave module 200 may determine that a signal is present.

The slave module 200 with a non-coherent structure may support digital conversion and demodulation. For example, the slave module 200 may convert detected energy into a digital signal, thereby demodulating original data.

Meanwhile, since the non-coherent structure reduces power consumption, the non-coherent structure may be applied to devices that require ultra-low power implementation, such as IoT devices or wearable devices in which extended battery life is important.

In relation to this, the ultra-low-power implementation according to the non-coherent structure may be achieved in low-power circuit design, for example, by designing a circuit by using low-power consumption components and applying voltage scaling and power gating techniques to block power of unnecessary parts, and in efficient signal processing, for example, by optimizing a signal processing algorithm to reduce the amount of computation and minimize power consumption.

In addition, in the ultra-low-power implementation based on the non-coherent structure, a clock is desirably designed to be activated only when necessary rather than being kept active at all times by using an asynchronous signal processing method, so that the clock can enter sleep mode. For example, the clock may switch to sleep mode when a device is not in use to reduce power consumption, and minimize time required to wake up from the sleep mode so that the clock can be activated quickly.

In addition, in the ultra-low-power implementation based on the non-coherent architecture, low-power communication protocols, for example, power-efficient communication protocols may be used to optimize data transmission, and a data compression technique may be used to reduce the amount of data to be transmitted.

In this way, the system based on the non-coherent structure enables simple design and low power consumption, and can provide efficient communication in applications in which battery life is important through ultra-low-power implementation, and enables the design of a stable and reliable UWB communication system with low power consumption.

Meanwhile, the ultra-wideband (UWB) wireless transmitter and receiver according to the present disclosure are able to simultaneously perform ultra-precision distance measurement and data communication with an average power of about 1 mW or less (in this case, on the basis of 1 Mops).

For example, Table 1 shows the performance comparison results of an ultra-wideband (UWB) transceiver (1Tx 1Rx) and a transceiver (1Tx 1Rx) according to the present disclosure.

TABLE 1

| | | | | | The present | |
|---|---|---|---|---|---|---|
| | Samsung U100 | | 22′ ISSCC | | disclosure | |
| Transceiver | 1Tx 1Rx | | 1Tx 1Rx | | 1Tx 1Rx | |
| Feature | | | | | | |
| Transmitter | 14.25 | dBm | 10 | dBm | >10 | dBm |
| Peak Power | | | | | | |
| Communication | 0.11~31.2 | Mbps | 0.11~31.2 | Mbps | ~100 | Mbps |
| speed | | | | | | |

| Power | About 662 mW | | About 211 mW | <1 mW | |
|---|---|---|---|---|---|
| consumption | (Peak) | | | (estimated) @ | |
| | | | | 1 Mbps | |
| Reception | −95.6 dBm | | −97 dBm | −80 dBm | |
| sensitivity | @ 6.5 GHz, 6.81 | | (estimated) | @ 6.5 GHz, | |
| | Mbps | | @ 6.5 GHz, 6.81 | 1 Mbps | |
| | | | Mbps | | |
| Distance | +−10 | cm | +−10 cm @ | <1 | cm |
| measurement | | | sensitivity | | |
| precision | | | | | |

| | | | | |
|---|---|---|---|---|
| Chip die size | 14.4 | mm² | 8.8 mm² (Only | <1 mm² w/o |
| | | | CMOS) | MODEM |

The present disclosure described above may be applicable to, for example, an ultra-wideband (UWB) system based on IEEE 802.15.4z. Due to this, the present disclosure may be widely used in ultra-low-power, non-contact, high-speed systems, such as medical and imaging/transmission/reception, brain-computing interface, microelectrode array systems.

In addition, due to the characteristics of the ultra-wideband (UWB) system, the ultra-wideband (UWB) system may be applied to automotive and mobile applications, enabling the development of highly reliable circuits. In other words, the ultra-wideband system according to the present disclosure may be utilized not only for vehicles and mobiles, but also for various connectivity applications in the future. In addition, the ultra-wideband system may be applied to image information transmission such as smart tags, VR, and XR including AR, and furthermore, may be extended to various fields, offering potential for industrial applications.

Although the present disclosure has been described above with reference to embodiments thereof, it will be readily apparent to those skilled in the art that the present disclosure may be modified and changed in various ways without departing from the spirit and scope of the present disclosure as set forth in the claims below.

What is claimed is:

1. An ultra-wideband round-trip wireless transceiver comprising:
a master module comprising a first transmitter and a first receiver for ultra-wideband round-trip data communication; and
a slave module comprising a second receiver and a second transmitter for the round-trip data communication,
wherein the master module further comprises a range finder module for two-way ranging that counts time simultaneously with transmission of an output signal of the first transmitter, and calculates a distance by receiving a signal output through the second transmitter at the first receiver by using a trigger according to the output signal of the first transmitter at the second receiver of the slave module.

2. The ultra-wideband round-trip wireless transceiver of claim 1, wherein the master module comprises:
a first part for generating pulses; and
a second part for transmitting signals comprising the pulses.

3. The ultra-wideband round-trip wireless transceiver of claim 2, wherein the first part comprises:
a modulator that modulates input data;
a window generator for a pulse trigger; and
an impulse generator module for synchronization.

4. The ultra-wideband round-trip wireless transceiver of claim 3, wherein the impulse generator module comprises:
timing combine logic; and
a push-pull strength stage processing module.

5. The ultra-wideband round-trip wireless transceiver of claim 1, wherein the slave module comprises:
a first part for receiving and processing an output signal of the master module; and
a second part that generates a signal to be output to the master module.

6. The ultra-wideband round-trip wireless transceiver of claim 5, wherein the first part comprises:
a plurality of amplifiers;
a detector for self-mixing; and
a comparator for pulse detection.

7. The ultra-wideband round-trip wireless transceiver of claim 6, wherein the second part processes a data demodulation path and a range finder path by distinguishing between the data demodulation path and the range finder path.

8. The ultra-wideband round-trip wireless transceiver of claim 7, wherein the data demodulation path comprises:
a data demodulator for demodulating data from an output of the comparator; and
a synchronization processing part configured to generate samples for pulse-based synchronization and to generate a recovery clock on the basis of the samples.

9. The ultra-wideband round-trip wireless transceiver of claim 7, wherein the range finder path is formed by an edge detector for detecting an edge from an output of the comparator, and a time-to-digital converter with a two-step Vernier structure for distance measurement.

10. The ultra-wideband round-trip wireless transceiver of claim 5, wherein the slave module uses a detection structure with a non-coherent structure.

11. The ultra-wideband round-trip wireless transceiver of claim 1, wherein the range finder module calculates the distance from time divided by speed of light on the basis of time of flight (ToF).

12. The ultra-wideband round-trip wireless transceiver of claim 11, wherein a modulator uses a synchronized on-off keying (S-OOK) technique as a modulation technique for the data communication of the round-trip.

13. The ultra-wideband round-trip wireless transceiver of claim 5, wherein the slave module uses a sync pulse and a data pulse to transmit data from an input clock according to the output signal of the first transmitter.
